(19) United States
(12) Patent Application Publication
(10) Pub. No.: US 2021/0306833 A1
(43) Pub. Date: Sep. 30, 2021

(54) DEVICE AUTO-PAIRING

(71) Applicant: Lenovo (Singapore) Pte. Ltd., Singapore (SG)

(72) Inventors: Russell Speight VanBlon, Raleigh, NC (US); Kevin Wayne Beck, Raleigh, NC (US); Thorsten Peter Stremlau, Morrisville, NC (US); Ratan Ray, Cary, NC (US)

(21) Appl. No.: 16/833,262

(22) Filed: Mar. 27, 2020

(51) Int. Cl. H04W 4/80; G06K 7/14

(52) U.S. Cl. CPC H04W 4/80; G06K 7/1413; G06K 7/1417

(57) ABSTRACT

One embodiment provides a method, including: identifying, using an information handling device, an aspect associated with another device; determining, based upon analysis of the aspect, whether the information handling device can be paired to the another device; and providing, responsive to determining that the information handling device can be paired to the another device, a pairing query to a user of the information handling device. Other aspects are described and claimed.

### BACKGROUND

Information handling devices (“devices”), for example, smart phones, tablets, head mounted devices (“HMDs”), smart watches, laptops, and the like, are capable of establishing wireless connections with each other. One popular method of wirelessly connecting two devices involves Bluetooth pairing (“pairing”). In this process, devices may register information with each other so that they can connect. Once two devices are paired, information can be exchanged via their connection and the pairing process does not need to be repeated.

### BRIEF SUMMARY

In summary, one aspect provides a method, comprising: identifying, using an information handling device, an aspect associated with another device; determining, based upon analysis of the aspect, whether the information handling device can be paired to the another device; and providing, responsive to determining that the information handling device can be paired to the another device, a pairing query to a user of the information handling device.

Another aspect provides an information handling device, comprising: a processor; a memory device that stores instructions executable by the processor to: identify an aspect associated with another device; determine, based upon analysis of the aspect, whether the information handling device can be paired to the another device; and provide, responsive to the determining that the information handling device can be paired to the another device, a pairing query to a user of the information handling device.

A further aspect provides a method, comprising: detecting, at an information handling device, pairing code metadata information; capturing, using a camera sensor, physical characteristics associated with another device; identifying, based on the capturing, the another device; determining, using a processor, whether the identified another device is associated with the detected pairing code metadata information; and providing, responsive to determining that the identified another device is associated with the detected pairing code metadata information, a pairing query to a user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of pairing two devices together.

FIG. 4 illustrates another example method of pairing two devices together.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Existing device pairing techniques require users to perform pairing functions on both devices in order to pair. These techniques may not always be user friendly and may cause frustration during implementation. Solutions exist that enable auto-pairing upon initial power-up of devices or upon initiation of certain applications. However, this pairing solution attempts to pair with all devices within a predetermined radius of the originating device, which may cause issues.

Accordingly, an embodiment provides a novel method for pairing two devices together. In an embodiment, a user's device may identify an aspect associated with another device. The aspect may correspond to one or more of: physical dimensions of the other device, logos and/or labels positioned on a surface of the other device, a pairing code sticker positioned on a surface of the other device, etc. Once this aspect is identified, an embodiment may determine whether the device can be paired to the other device (e.g., by comparing the identified aspect associated with the other device with a list of aspects associated with pairable devices, etc.). Responsive to determining that the other device can be paired to the user's device, an embodiment may either automatically pair the devices together or prompt a user whether they want to initiate a pairing procedure. Such a method facilitates more user friendly and secure device pairing between two devices while avoiding pairing with unintended devices.

The illustrated example embodiments will be best understood by reference to the figures. The following description is intended only by way of example, and simply illustrates certain example embodiments.

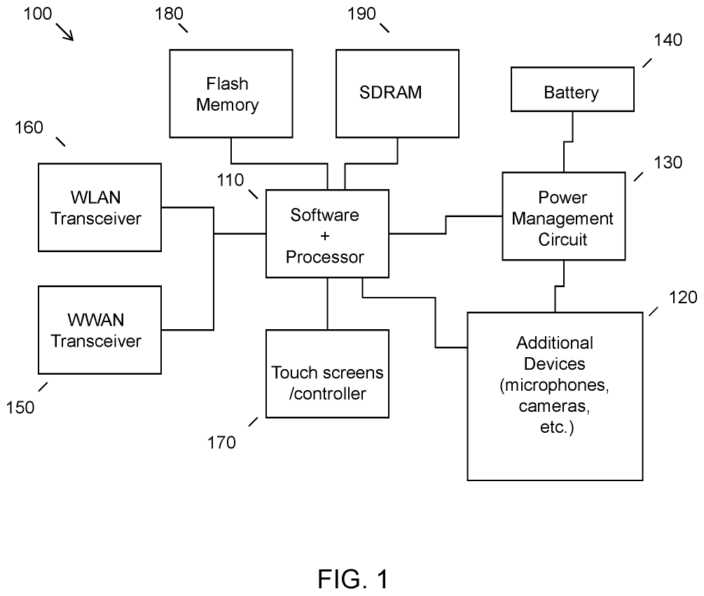

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

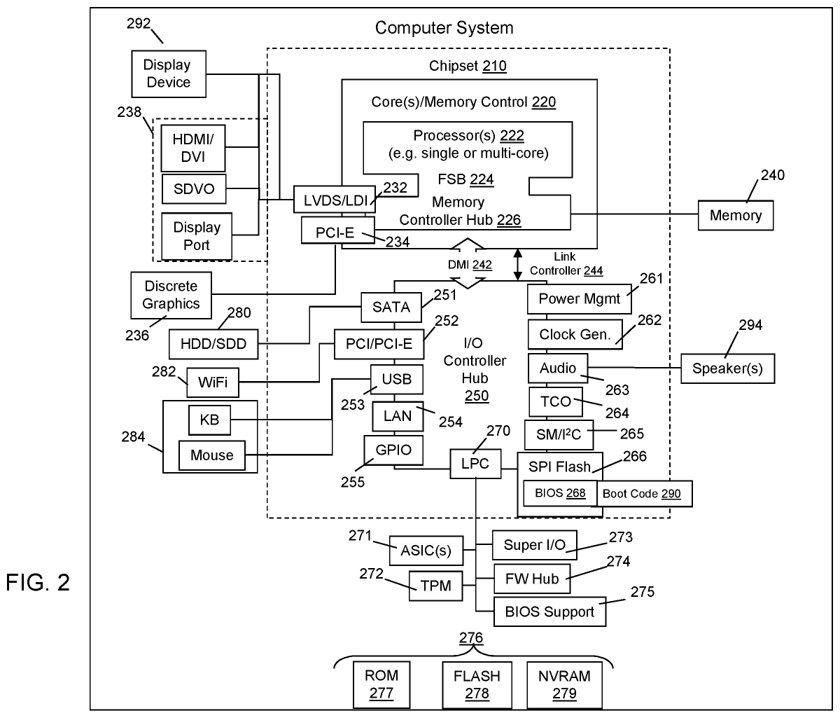

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices capable of pairing with one or more other devices. For example, the circuitry outlined in FIG. 1 may be implemented in a smart phone or tablet embodiment, whereas the circuitry outlined in FIG. 2 may be implemented in a laptop.

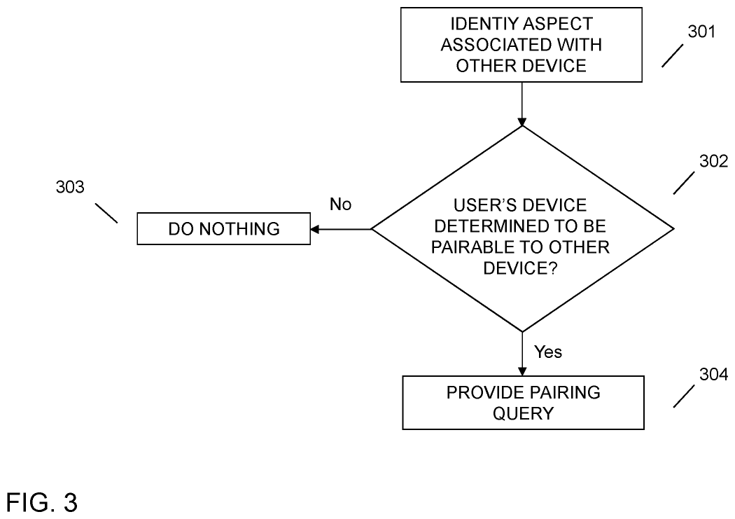

Referring now to FIG. 3, an embodiment provides a method of pairing two intended devices together without pairing an unintended device. At 301, an embodiment may utilize a user's device to identify an aspect associated with another device noticed by the user's device. The identification may be facilitated via utilization of at least one camera sensor integrally or operatively coupled to the user's device. The camera sensor(s) may be configured to continually attempt to capture and identify devices, or aspects of devices, when it is on. In an embodiment, if the camera notices a device within its field of view, a notification may be transmitted to the user to direct their device closer to the noticed device or position the noticed device more squarely within the camera's field of view. In an embodiment, the user's device may be virtually any device capable of capturing an image or video of a scene and capable of performing pairing functions with other devices. For simplicity purposes, the remaining disclosure will be described with reference to a user wearable headset as the user's device.

In an embodiment, the aspect may correspond to the physical characteristics of a device. As used herein, physical characteristics may encompass the shape of the device, the physical dimensions of the device, the texture of the device, etc. In another embodiment, the aspect may correspond to any logos, labels, or designs presented on a surface of a device. For example, an embodiment may be able to identify any names or designs present on the surface of the device that may provide an indication of the device brand and/or the device model. In yet another embodiment, an aspect may correspond to a pairing code sticker positioned on a surface of the other device. The pairing code sticker may contain coded pairing information presented in the form of one of: a QR code, a barcode, an alphanumeric code, etc. The decision regarding the particular type of aspect an embodiment may be looking for may be originally set by a manufacturer and/or later adjusted by a user.

At 302, an embodiment may determine whether the noticed device may be pairable with the user's device. The determination technique used may be based at least partially on the aspect that is identified. For example, if a pairing code sticker was readily visible on the surface of a noticed device, an embodiment may simply analyze the sticker to determine if the code was relevant to pairing. In another example, an embodiment may rely on just the identified physical characteristics of a noticed device to make this determination. Such reliance may be due to user choice or may simply be because a pairing code sticker was not visible or present. In this situation, the determination may be facilitated by first accessing a list of pairable devices that may be stored at an accessible storage location (e.g., locally on the user's device or remotely on another device or server, etc.). The list of pairable devices may contain physical characteristic information for some or all of the devices in the list. An embodiment may then compare the identified physical characteristics of the noticed device against the pairable devices in the list. If a match is identified, an embodiment may be able to determine the identity of the noticed device and/or may also conclude that the noticed device is a device that is appropriately pairable with the user's device. A similar technique to the foregoing may be used if the aspect relied upon corresponded to various designs or logos present on the surface of a noticed device.

Responsive to determining, at 302, that an embodiment is not pairable with the other device, an embodiment may, at 303, take no pairing action with this device. Additionally or alternatively, an embodiment may provide a notification to a user informing them that the noticed device is not pairable. Conversely, responsive to determining, at 302, that an embodiment is pairable with the other device, an embodiment may, at 304, either automatically pair with the other device or provide the user with a pairing query (e.g., via an audible or visual notification, etc.). The pairing query may inform the user that the two devices are pairable and/or may ask the user whether they wish to initiate a pairing process with the pairable device. Responsive to receiving pairing confirmation input by the user, an embodiment may initiate pairing between the devices.

In situations where a pairing code sticker is readily visible and identified, an embodiment may utilize the pairing information encoded in the sticker to facilitate pairing. However, in situations where a pairing code sticker may not be readily visible, an embodiment may provide the user with additional details regarding how to find the pairing code sticker or pairing information. For example, once the identity of the device is known, an embodiment may have knowledge regarding where a pairing code sticker is located on the identified device. Accordingly, in a situation where the pairing code sticker may be located on a bottom surface of a laptop, an embodiment may instruct the user to flip the device over and place the pairing code sticker within their device's camera's field of view. The instructions may be provided visually (e.g., presented on a display of the user's headset, etc.), audibly (e.g., via one or more speakers on the device, etc.), or a combination thereof.

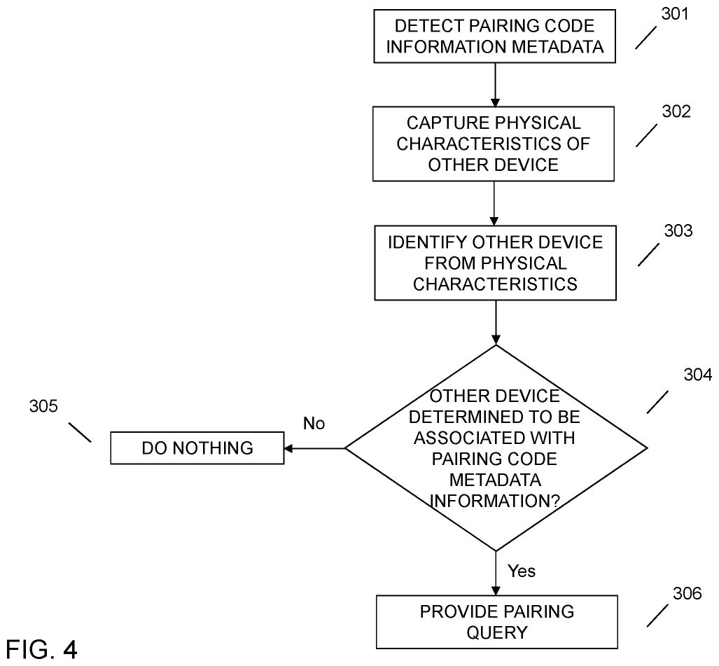

Referring now to FIG. 4, an embodiment may facilitate pairing using a similar, but different, technique. At 401, an embodiment may detect pairing code metadata information. This information may be transmitted to the user's device via a wireless communication from another device. The user's device may be configured to continuously monitor for this type of information or, alternatively, may be configured to monitor for this type of information at predetermined intervals. At 402, an embodiment may capture the physical characteristics of a device noticed by the user's device (e.g., via a camera sensor of the user's device, etc.) and thereafter determine, at 403, the identity of this noticed device. The foregoing capturing and determination processes are similar to the determination process outlined in step 302 above.

At 404, an embodiment may determine whether the identified device is associated with the detected pairing code metadata information. Stated differently, an embodiment may determine whether the identified device is a device that could be paired to by using the pairing code metadata information. Such a determination may be facilitated by first identifying, within the pairing code metadata information, an identity of the broadcasting device. Once the identities of the broadcasting device and the noticed device are known they can be compared to determine if there is a match.

Responsive to determining, at 404, that the identified device is not associated with the detected pairing code metadata information, an embodiment may, at 405, take no additional action. Additionally or alternatively, an embodiment may provide a notification to a user informing them that the detected pairing code metadata information does not match the identified device. Conversely, responsive to determining, at 404, that the identified device is associated with the detected pairing code metadata information, an embodiment may, at 406, either automatically pair with the other device or provide the user with a pairing query (e.g., via an audible or visual notification, etc.).

The various embodiments described herein thus represent a technical improvement to conventional methods of pairing two devices together. In an embodiment, an aspect associated with a device may be identified. An embodiment may then determine whether the user's device may be paired to the other device based upon analysis of this aspect. Responsive to determining that the two devices are pairable, an embodiment may either automatically pair the two devices together or may provide a pairing query to a user. In another method, an embodiment may detect pairing code metadata information from a wireless transmission. To confirm the device that transmitted this information, an embodiment may determine the identity of any visible devices proximate to the user's device (e.g., via analysis of their physical characteristics, etc.) and, based upon this identification, determine whether there is a match with the detected pairing code metadata information. If such a match is determined, an embodiment may either automatically pair the two devices together or may provide a pairing query to a user. Such methods facilitate more user friendly and secure device pairing between two devices while avoiding pairing with unintended devices.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, using an information handling device, an aspect associated with another device;
determining, based upon analysis of the aspect, whether the information handling device can be paired to the another device; and
providing, responsive to determining that the information handling device can be paired to the another device, a pairing query to a user of the information handling device.

2. The method of claim 1, wherein the information handling device is a user wearable headset.

3. The method of claim 1, wherein the aspect corresponds to physical characteristics of the another device.

4. The method of claim 3, wherein the determining comprises:
accessing a list of pairable devices, wherein the list comprises physical characteristic information for each of the pairable devices in the list;
comparing the physical characteristics of the another device to the physical characteristic information for each of the pairable devices in the list; and
identifying, based on the comparing, whether a match exists between the another device and one of the pairable devices.

5. The method of claim 3, further comprising providing, to the user, instructions to access pairing information located on a surface of the information handling device.

6. The method of claim 5, further comprising capturing, using a sensor of the information handling device, the pairing information.

7. The method of claim 1, wherein the aspect is a sticker positioned on a surface of the information handling device, wherein the sticker contains pairing information.

8. The method of claim 7, wherein the sticker is selected from the group consisting of a QR code, barcode, and an alphanumeric code.

9. The method of claim 1, further comprising pairing, responsive to receiving a pairing instruction from the user in response to the pairing query, the information handling device to the another device.

10. The method of claim 1, further comprising providing, prior to the identifying, an instruction to the user to direct a field of view of a camera sensor associated with the information handling device toward the another device.

11. An information handling device, comprising:
a processor;
a memory device that stores instructions executable by the processor to:
identify an aspect associated with another device;
determine, based upon analysis of the aspect, whether the information handling device can be paired to the another device; and
provide, responsive to the determining that the information handling device can be paired to the another device, a pairing query to a user of the information handling device.

12. The information handling device of claim 11, wherein the information handling device is a user wearable headset.

13. The information handling device of claim 11, wherein the aspect corresponds to physical characteristics of the another device.

14. The information handling device of claim 13, wherein the instructions executable by the processor to determine comprise instructions executable by the processor to:
access a list of pairable devices, wherein the list comprises physical characteristic information for each of the pairable devices in the list;
compare the physical characteristics of the another device to the physical characteristic information for each of the pairable devices in the list; and
identify, based on the comparing, whether a match exists between the another device and one of the pairable devices.

15. The information handling device of claim 13, wherein the instructions are further executable by the processor to provide, to the user, instructions to access pairing information located on a surface of the information handling device.

16. The information handling device of claim 15, wherein the instructions are further executable by the processor to capture, using a sensor of the information handling device, the pairing information.

17. The information handling device of claim 11, wherein the aspect is a sticker positioned on a surface of the information handling device, wherein the sticker contains pairing information.

18. The information handling device of claim 17, wherein the sticker is selected from the group consisting of a QR code, barcode, and an alphanumeric code.

19. The information handling device of claim 11, wherein the instructions are further executable by the processor to pair, responsive to receiving a pairing instructions from the user in response to the paring query, the information handling device to the another device.

20. A method, comprising:
detecting, at an information handling device, pairing code metadata information;
capturing, using a camera sensor, physical characteristics associated with another device;
identifying, based on the capturing, the another device;
determining, using a processor, whether the identified another device is associated with the detected pairing code metadata information; and
providing, responsive to determining that the identified another device is associated with the detected pairing code metadata information, a pairing query to a user.
